(19) United States
(12) Patent Application Publication
(10) Pub. No.: US 2005/0188492 A1
(43) Pub. Date: Sep. 1, 2005

(54) Trowel

(76) Inventor: Duane Arthur Coon, Star, ID (US)

Correspondence Address: Duane Arthur Coon, 11051 W. 1st St., Star, ID, 83669, US

(21) Appl. No.: 10/788,213

(22) Filed: Feb. 27, 2004

(51) Int. Cl. B05C 17/10

(52) U.S. Cl. 15/235.4

(57) ABSTRACT

An invention that uses a convex shaped tool in the application and smoothing of concrete, but also can be used in other fields where needed where there is a concave surface. This trowel will be a big help in many variety of fields that has to deal with different degrees of concave surfaces. This trowel has a need to come in many different sizes, convex shapes, and composition depending on the need in the desired job being worked on. This trowel will be a big help in areas of concave surfaces where before there was no universal tool to do those jobs quickly and efficiently.

### BACKGROUND OF THE INVENTION

1. Field of the Invention

The subject invention relates to a trowel that has a convex shape. The convex shape applies to both the float trowel and finishing trowel. The convex shape of these tools allows a person to do virtually any concrete job application that has a concave surface.

2. Prior Art

Concrete trowels are used to spread and set up a concrete surface like a sidewalk, road, foundation, curbs, pools etc. and then a finishing trowel is than used to get the smooth finish and the sealing of the concrete. All trowels are flat with some variations as in length, width, square or rounded ends, or they are a specific shape like a concrete edger for the 90 degree curbwork. The pool trowel having rounded ends won't cut into concrete like a square trowel will and is used for gradual concave surfaces like a swimming pool, or a sweeping roadside curb the design of the convex trowel is like no other trowel in excistance at this time, so there is no prior art to speak of.

The convex structure of this trowel can still do some of the jobs the other types of trowels can do, but with the shape of this tool it allows much tighter concave surfaces to be handled. For instance, front yard ponds if made out of concrete are very hard to get a smooth surface and a sealing on the surface because all existing trowels and pool trowels cannot handle the tight concave surfaces without marring the surface up in the process. The convex trowel furnishes a way to do these tight concave surfaces smoothly and efficiently while also allowing a smooth surface to be applied without cutting into the surface being worked on.

### BRIEF SUMMARY OF THE INVENTION

The novel construction of the invention allows the majority of concave surfaces to be prepared, smoothed if needed and sealed. Some examples of these concave surfaces could be in curbs, pools, ditches, ponds, etc. in varying degrees. Different sizes of the trowel and adjustments on the angles in the convex trowel can help in doing tighter surfaces or more gradual surfaces depending on its need. With a bigger or longer tool you can do a more gradual application.

With the convex shape of this tool you will not be marring your job application with cuts into your surface area because there is no sharp end of the trowel to cut into your material with. Flat trowels and pool trowels when up against tighter concave surfaces will tend to cut into your surface since their design was not for such surfaces. This tool is to solve the problem of not being able to create a smooth concave surface.

### BRIEF DESCRIPTION OF THE SEVERAL VIEWS OF THE DRAWING

FIG. 1 is a top perspective view of a typical convex trowel.

FIG. 2 is a bottom perspective view of a typical convex trowel.

### DETAILED DESCRIPTION OF THE INVENTION

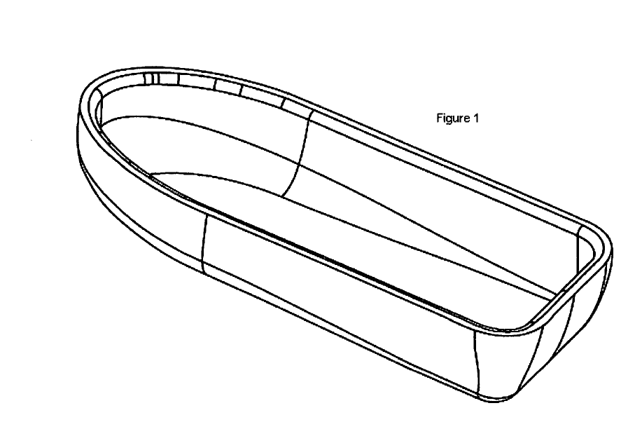

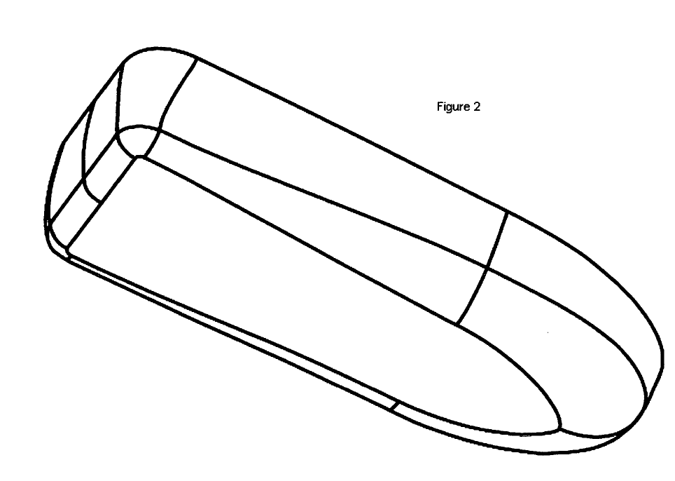

The convex trowel is a new design in the concrete trowel field. The whole point of the design of this trowel is centered on its convex shape. The convex shape allows a person with any variation of this tool to be able to work with concave concrete surfaces in greater and lesser degrees. Variations of this tool can be as simple as being longer, shorter, wider, lesser or greater angles in the convex of its shape. An example of an invention of many different shapes is the wheelbarrow. The convex trowel can be made in a variety of sizes and shapes, as long as it keeps its overall convex shape. One example of this trowel is in FIG. 1 and FIG. 2 in the attached drawings.

1. A convex shaped trowel that is made from a material best for the desired application of a concave concrete surface.

2. The convex trowel in claim 1, wherein can consist of any type of material, like different consistencies of metal, rubber, plastic, or any other suitable material needed in the desired concrete application.

3. The convex trowel in claim 2, wherein depending on the concrete application can come in many different sizes and variations of shape in greater and lesser degrees as long as it keeps an overall convex shape.

4. The convex trowel in claim 1. Thru 3. Wherein can be used as a float trowel or finishing trowel depending on its composition.

5. The convex trowel in claim 1. Thru 4. Wherein can also be used in other fields that also has a concave surface to be worked on.
